(19) United States
(12) Patent Application Publication
(10) Pub. No.: US 2012/0201210 A1
(43) Pub. Date: Aug. 9, 2012

(54) TERMINAL AND METHOD FOR DATA COMMUNICATION USING MULTIPLE WIRELESS COMMUNICATION METHODS

(75) Inventors: Eun Yeong AN, Seoul (KR); Sang Im JO, Seoul (KR)

(73) Assignee: PANTECH CO., LTD., Seoul (KR)

(21) Appl. No.: 13/365,634

(22) Filed: Feb. 3, 2012

(30) Foreign Application Priority Data
Feb. 9, 2011 (KR) 10-2011-0011474

(51) Int. Cl. H04W 72/04

(52) U.S. Cl. 370/329

(57) ABSTRACT

In a terminal and method for data communication using multiple wireless communication methods, a terminal includes an input unit to receive an instruction of a user; a communication unit to transmit and receive data to and from other terminals; and a control unit to determine a first seed file based on the instruction, to search other terminals having a seed file corresponding to the first seed file, and to receive data corresponding to the seed file from the searched other terminals.

### CROSS-REFERENCE TO RELATED APPLICATION

This application claims priority from and the benefit under 35 U.S.C. §119(a) of Korean Patent Application No. 10-2011-0011474, filed on Feb. 9, 2011, which is incorporated by reference for all purposes as if fully set forth herein.

### BACKGROUND

1. Field

The present disclosure relates to a terminal and method for data communication using multiple wireless communication methods

2. Discussion of the Background

As wireless network techniques and related infrastructures have developed, is people may obtain desired data without time and place restrictions by using mobile terminals, such as smart phones, notebooks, and personal digital assistants (PDA), and desktop personal computers (PC). Accordingly, local community meetings and sharing of mass storage contents have increased and become more active. Further, a rapid peer-to-peer (P2P) communication may be needed among mobile terminals.

However, in implementing a P2P communication among mobile terminals, there may be some limitations on bandwidth depending on communication method. Mobile terminals have various maximum data transmission rates depending on their wireless communication methods, such as 2G, 3G, 4G and Wi-Fi®, and the bandwidth of a device which transmits data decreases if the number of devices, which access to the device and receive the data, decrease.

FIG. 1 is a diagram illustrating a bandwidth allocation according to the related art.

As shown in FIG. 1, if the bandwidth of a source provider 1, which provides a data file, is X MBps, and three source acceptors 3, 5 and 7 are connected thereto, the data transmission rate decreases to ⅓ of X MBps for each of the three source acceptors 3, 5 and 7. For this reason, in order to ensure the speed of X MBps, three source acceptors should download the data file in turns.

If a mobile terminal uses one communication method at a time to communicate with another device, and the mobile terminal serves as a wireless access point (AP), the rate of the maximum bandwidth decreases in proportion to the number of source acceptors, and therefore the data transmission rate of each source acceptor rapidly decreases. In addition, if a large data file is transmitted, the communication method may not be changed during the transmission of the data file. For this reason, if the transmission rate deteriorates, it may be needed to quit the network connection and then transmit/receive the data file again.

### SUMMARY

Exemplary embodiments of the present invention provide a terminal and method for data communication using multiple wireless communication methods. The terminal and method may improve a data communication rate based on peer-to-peer (P2P) communication using multiple wireless communication methods.

Additional features of the invention will be set forth in the description which follows, and in part will be apparent from the description, or may be learned by practice of the invention.

Exemplary embodiments of the present invention provide a terminal including an input unit to receive an instruction of a user; a communication unit to transmit and receive data to and from other terminals; and a control unit to determine a first seed file based on the instruction, to search other terminals having a second seed file corresponding to the first seed file, and to receive data corresponding to the second seed file from the searched other terminals using a wireless communication method.

Exemplary embodiments of the present invention provide a method for data communication, including establishing a first wireless channel with one or more terminals; determining a first seed file to receive data corresponding to the seed file; searching one or more terminals having a second seed file corresponding to the first seed file; and receiving data corresponding to the second seed file from the one or more terminals using the first wireless channel.

It is to be understood that both forgoing general descriptions and the following detailed description are exemplary and explanatory and are intended to provide further is explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a bandwidth allocation according to the related art.

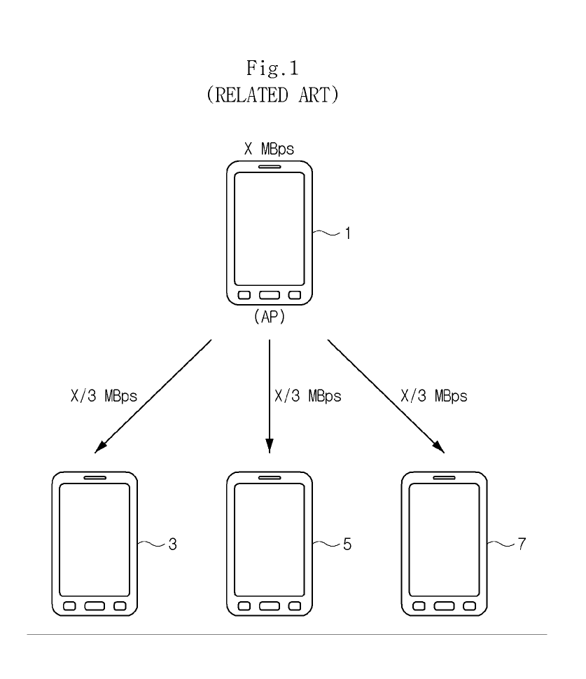

FIG. 2 is a schematic view showing a terminal according to an exemplary embodiment of the present invention.

FIG. 3 is a diagram showing a data communication method based on a peer-to-peer data communication using multiple wireless communication methods according to an exemplary embodiment of the present invention.

FIG. 4 is a flowchart illustrating a method for receiving data based on a peer-to-peer data communication using multiple wireless communication channels according to an exemplary embodiment of the present invention.

FIG. 5 is a flowchart illustrating a method for transmitting data based on a peer-to-peer data communication using multiple wireless communication channels according to an exemplary embodiment of the present invention.

### DETAILED DESCRIPTION OF THE ILLUSTRATED EMBODIMENTS

Exemplary embodiments will now be described more fully hereinafter with is reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure is thorough, and will fully convey the scope of the invention to those skilled in the art. Throughout the drawings and the detailed description, unless otherwise described, the same drawing reference numerals are understood to refer to the same elements, features, and structures. The relative size and depiction of these elements may be exaggerated for clarity, illustration, and convenience. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

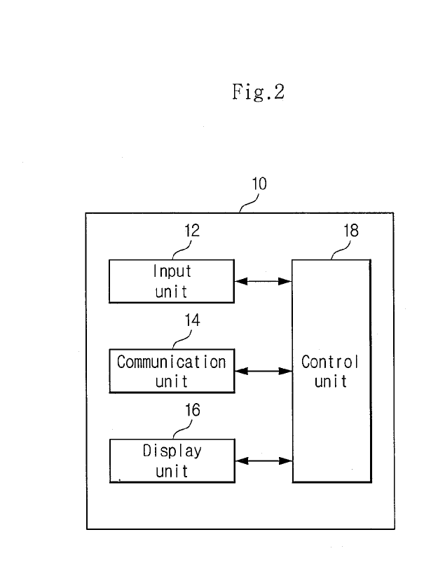

FIG. 2 is a schematic view showing a terminal according to an exemplary embodiment of the present invention.

Referring to FIG. 2, the terminal 10 includes an input unit 12, a communication unit 14, a display unit 16 and a control unit 18.

The input unit 12 may receive an instruction of a user, and the input unit 12 may include a key input, such as via buttons, or a touch screen. The input unit 12 and the display unit 16 may be configured to form a touch screen.

The communication unit 14 may include an antenna disposed in the terminal 10. The communication unit 14 may transmit and receive data to and from another terminal. Further, the terminal 10 may be a mobile terminal, such as a smart phone, and another terminal may be a communication device, such as a smart phone, a PC or other IT devices. The communication unit 14 may include a first wireless communication unit (not shown), a second wireless communication unit (not shown). The first wireless communication unit and the second wireless communication unit may be used to transmit and receive data using a P2P communication method. Further, the first wireless communication unit and the second wireless communication unit may use different wireless communication methods to establish a wireless communication channel for the P2P communication. The communication unit 14 may receive a is portion of data from multiple peer terminals using multiple wireless communication units, thereby enabling a multiple peer-to-peer data communication.

The display unit 16 may display various operation states of the terminal 10. Further, the display unit 16 may provide a user with a connection state with another terminal or a data transmission state through a user interface (UI) when transmitting and receiving data to and from another terminal. The display unit 16 may display multiple peer terminals wirelessly connected to the terminal 10, available wireless communication methods of the multiple peer terminals, and data communication rate of each of the available wireless communication methods.

If the user executes or determines a seed file through the input unit 12, the control unit 18 may search other terminals having the same seed file corresponding to the seed file executed or determined by the user through the communication unit and receive data corresponding to the seed file from the other terminals. The search operation and the data transmission operation may be performed using multiple wireless communication methods, such as Wi-Fi, 3G, Bluetooth, and the like.

The control unit 18 may control data communication based on a peer-to-peer (P2P) file exchanging method using multiple wireless communication methods.

For a P2P data communication in a wireless communication environment, a wireless communication terminal initiates available wireless communication methods and establishes a wireless network connection, a wireless communication channel, with other terminals. The wireless communication terminal may share the bandwidth of each wireless communication network with other terminals and may process information together with other terminals. Each client terminal may serve as a client and a server at the same time in the P2P is data communication environment. The control unit 18 may open a seed file containing the information of a data file to be shared among other users and a web server. A provider of the original source of a data file to be shared is referred to as a seeder. Then, each peer who wants to acquire a shared data file may acquire a list of other peers or seeders who provide the shared data file through the seed file, and may download the shared data file. The P2P technique may be a torrent-based communication method, for example, a Bit Torrent (BT) technique; however, aspects are not limited thereto.

A shared data file may not be downloaded as a whole but may be classified by a packet so that data may be transmitted from peers who share each packet data. That is, a data file may be received from multiple seeders having at least a portion of the data file. If a first peer receives a shared data file from the seeder (at this time, the original data file may not be entirely transmitted to the peer) and the first peer shares the received data file, a second peer who wants to acquire the shared data file may receive the data from any peer, i.e., the seeder and the first peer, who has the packet data. Thus, the bandwidth may be expanded as packets are received from different peers at the same time, since many peers who receive a shared data file may be distributed to many different peers who have and share at least one packet of the shared data file. Further, the second peer may receive a first packet of the data file from the seeder and receive a second packet of the data file from the first peer simultaneously using different wireless communication methods.

Further, multiple terminals may be connected through an AP using a wireless communication method, such as Wi-Fi, to share data files using P2P data communication in a wireless environment. Further, multiple wireless communication methods, such as Wi-Fi and a 3 G communication network, may be used together. Further, packets of a data file may be is transmitted from the first packet if established communication channel is Wi-Fi, and packets of the data file may be transmitted from the last packet if established communication channel is 3G when using dual wireless communication channels to receive a common data file.

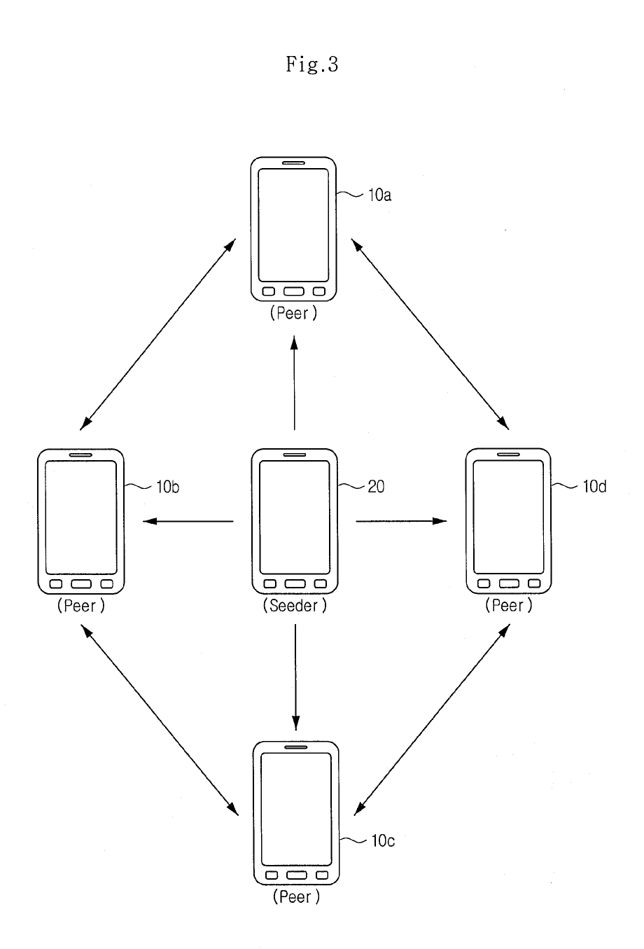

Hereinafter, the data communication method based on the P2P data communication using multiple wireless communication methods will be described in more detail with reference to FIG. 3.

FIG. 3 is a diagram showing a data communication method based on a peer-to-peer data communication using multiple wireless communication methods according to an exemplary embodiment of the present invention.

Referring to FIG. 3, terminals including a seeder terminal 20 and peer terminals 10a, 10b, 10c and 10d may be connected with each other using one or more wireless communication methods. The terminals may be a wireless communication device, such as a smartphone, PDA, and a tablet computer. The terminals may communicate with each other using multiple wireless communication methods, such as Wi-Fi, 3G, 4G, and the like.

As shown in FIG. 3, the terminal 20 may serve as a seeder, which shares and transmits an original data file to the peers 10a, 10b, 10c and 10d. The terminals 20, 10a, 10b, 10c and 10d may be connected in various communication methods, respectively. Further, the terminals 20, 10a, 10b, 10c and 10d may be connected through the same access point (AP) while sharing the same internet protocol (IP) address, or the terminal 20, which provides a data file, may be the AP and the terminals 10a, 10b, 10c and 10d, which receive the data file, may be connected to the AP. The AP may be an access point of the Wi-Fi communication method.

In addition to the Wi-Fi method, various communication methods, such as Bluetooth, Zigbee, UWB, Infrared communication or the like, may be used. In addition to such is local communication networks, mobile communication networks, such as 2G, 3G and 4G using a communication network of a mobile communication service provider, may be used for connection. However, in order to transmit and receive a shared file to and from other terminals by using a mobile communication network, a base station of the mobile communication network and a separate system may be provided.

If the terminals 20, 10a, 10b, 10c and 10d are connected through a wireless communication network, such as Wi-Fi or 3G, the terminal 20, a seeder having an original data file, may transmit data to a terminal, which requests transmission of the original data file. If all of the terminals 10a, 10b, 10c, and 10d request transmission of the data file, the bandwidth decreases to ¼ if the data file is transmitted using one communication method at the same time. To avoid slower transmission of the data file according to the bandwidth reduction, some terminals may receive the data file through Wi-Fi and other terminals may receive the data file through the 3 G communication network such that the data transmission rate is increased.

If the terminals 10a, 10b, 10c and 10d do not request the transmission of the data file at the same time but at different times, the data transmission rate may be increased based on the P2P communication method.

In an example, the peer terminal 10a starts to receive the data file for the first time from the seeder terminal 20 and then the terminals 10b, 10c and 10d requests the transmission of the data file sequentially. If the peer terminal 10a receives a 10^{th} packet, the peer terminal 10b may start requesting the first packet of the data file to the seeder terminal 20 or the peer terminal 10a having the first packet. Then, the peer terminal 10b determines which terminal provides a faster data transmission rate between the seeder terminal 20 and the peer terminal 10a and downloads the first packet of the data file from the determined terminal. If the seeder terminal 20 supports only Wi-Fi and the peer terminal 10a supports both Wi-Fi and 3 G communication network, the peer terminal 10b may receive the first packet from the peer terminal 10a through the 3 G communication network so that the first packet may be received faster regardless of a Wi-Fi bandwidth status.

Further, each peer terminal may share a data file while receiving the data file and may select a peer, which may transmit a packet of the data file at a fastest rate among peers who have the packet of the data file. Specifically, each peer terminal may share a packet of a data file through available wireless communication channel right after receiving the packet of the data file from other terminal. For this purpose, each terminal may operate multiple communication methods at the same time such that data may be received and transmitted at the same time. Specifically, the control unit 18 may control to transmit the data to another terminal, which requests the transmission of the data, through a first communication method different from a second communication method while receiving the data from a seeder terminal through the second communication method. The first communication method and the second communication method are selected among multiple communication methods adopted by the terminal 10. For example, the control unit 18 may establish a reception channel to receive data using Wi-Fi, and may establish a transmission channel to transmit the data using 3G mobile communication method; however, aspects need not be limited thereto.

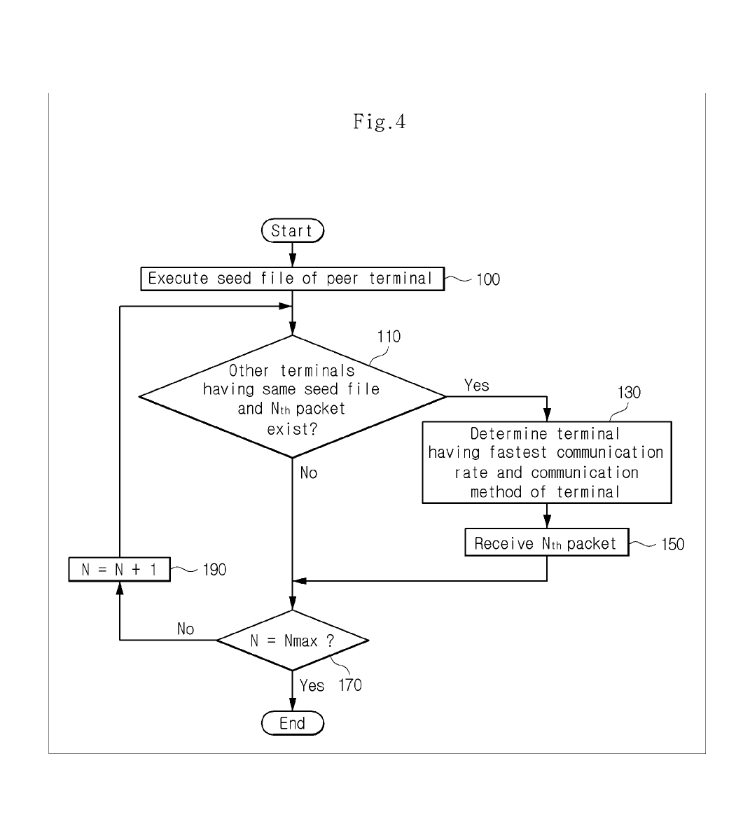

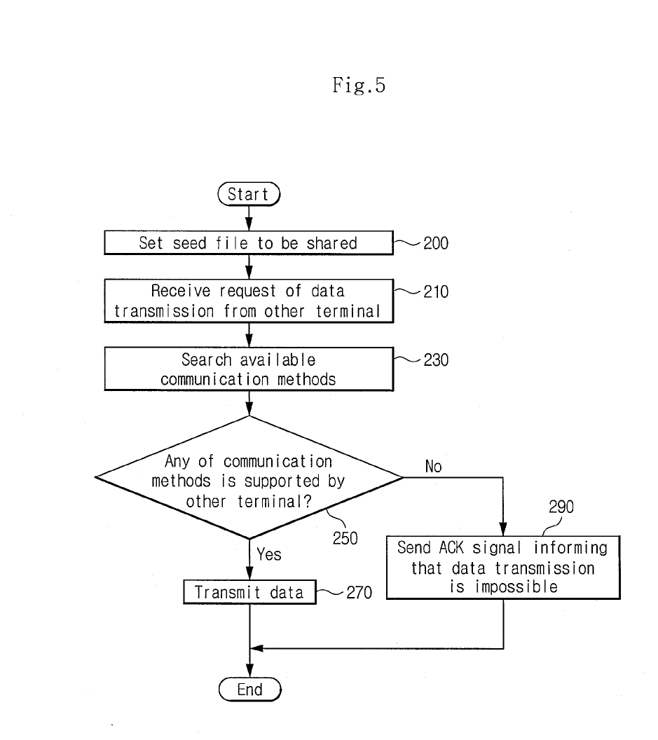

Hereinafter, data communication methods using a terminal will be described with reference to FIG. 4 and FIG. 5. FIG. 4 and FIG. 5 will be described according to the process performed by the terminal 10 shown in FIG. 2. However, FIG. 4 and FIG. 5 are not limited as such.

FIG. 4 is a flowchart illustrating a method for receiving data based on a peer-to-peer data communication using multiple wireless communication channels according to an exemplary embodiment of the present invention.

An application for supporting a P2P-based data transmission method may be installed in the terminal 10 or a user may download the application from other source, such as a website.

If a user executes the application to execute a first seed file of a peer terminal in operation 100, the peer terminal searches for a seeder terminal, which has the same seed file as the first seed file in operation 110. A transmission of data may be requested on a packet-by-packet basis for each packet. When requesting data packets, multiple data packets may be requested at the same time if the seeder terminal has corresponding data packets to transmit. Further, data packets may be requested in order from the first data packet to the next data packet. Further, the peer terminal may request several packets at a same time and receive available packets from several terminals at a same time.

In operation 110, data packets may be requested to other terminals sequentially from the first packet. The control unit searches one or more seeder terminals, which have the first seed file and the first packet corresponding to the first seed file. If it is determined that multiple terminals have the first packet, a transmission terminal, which provides the fastest communication rate, may be determined among the multiple terminals and a communication method of the transmission terminal may be determined among multiple communication methods available for the peer terminal and the transmission terminal in operation 130. For example, a terminal A is capable of both Wi-Fi and 3 G communication network and a terminal B is capable of 3 G communication network only and the Wi-Fi communication method used by the terminal A allows faster data communication rate than the 3 G communication method used by is the terminal B. Then, the peer terminal may select the terminal A and perform data communication using the Wi-Fi communication method.

If the connection is made to the transmission terminal capable of the fastest communication rate using the fastest communication method, the first packet is received in operation 150. If the first packet is received, the number of packet of the data file may be confirmed to determine whether the number of packet is equal to Nmax, the number of the last packet of the data file in operation 170. If the number of packet is equal to Nmax, it is determined that the transmission of the data file is completed, and then the data transmission process terminates.

However, if the number of packet is not equal to Nmax, it is determined that the transmission of the data file is not completed. Therefore, the number of packet may be increased by 1 to download the next packet in operation 190, and then the process returns to the operation 110. Further, if a transmission terminal and a communication method are determined, the peer terminal may use the same communication method to receive other packets of the data file shared by the transmission terminal.

If it is determined that there is no terminal having the same seed file or it is determined that no terminal is capable of providing the first packet in the operation 110, the process goes to the operation 170 to determine whether the number of packet is equal to Nmax. If the number of packet is not equal to Nmax, the number of packet is increased by 1 in operation 190 and the process returns to the operation 110 to search currently downloadable packets from the second packet sequentially. However, aspects of the present invention are not limited as such. Available packets may be downloaded regardless of sequential order.

After the first packet is completely downloaded in operation 150, the process may is return to the operation 110 to search for seeder terminals, which have the second packet because terminals, which share and provide each packet, may vary in real time, and their data transmission rates may vary in real time. The peer terminal may select another transmission terminal, which provides the fastest data transmission rate, whenever each packet is completely downloaded, and the fastest data transmission method of the transmission terminal may be selected to receive next data packet, thereby expanding the bandwidth of the communication network. Further, once a transmission terminal and a communication method are selected, the peer terminal may receive data packets without changing the transmission terminal and the communication method if the data transmission rate of the data packets is greater than or equal to a threshold rate. If the data transmission rate of the data packets is less than the threshold rate, the peer terminal may stop receiving data packets from the transmission terminal and perform operation 110 to search another transmission terminal to receive next packet.

In order to increase data transmission rate, more peer terminals, which share the received data, may be connected in the network and serve as seeder terminals in addition to the transmission terminal. Hereinafter, a method for sharing and transmitting data will be described with reference to FIG. 5.

FIG. 5 is a flowchart illustrating a method for transmitting data based on a peer-to-peer data communication using multiple wireless communication channels according to an exemplary embodiment of the present invention.

A seeder terminal may receive data from a seeder or a peer terminal and set a seed file to be shared in operation 200, thereby preparing data corresponding to the seed file to be transmitted to other terminals. Other peer terminals may search the seed file of the data and request the seeder terminal to transmit the data in operation 210. The seeder terminal may search is available communication methods for data transmission, which may be currently used by the seeder terminal in operation 230.

When the seeder terminal is receiving data, the bandwidth decreases if the seeder terminal transmits data to another terminal using the same communication method. Therefore, the seeder terminal may be set to not transmit data to another terminal using the same communication method as the communication method for receiving the data. For example, when the seeder terminal is receiving data using the Wi-Fi communication method, the seeder terminal may not transmit data if other communication methods, such as 3 G communication method, Bluetooth and infrared communication, are not available for the transmission of the data.

If available communication methods are searched, it is determined whether another terminal supports any one of the searched available communication methods in operation 250. If there is a communication method supported by another terminal, the data is transmitted using the communication method supported by another terminal in operation 270. If multiple communication methods are available, the data may be transmitted using the fastest communication method. If there is no available communication method or if there is an available communication method but this communication method is not supported by another terminal, an acknowledgement (ACK) signal, informing that the transmission of data is not available, may be sent to another terminal in operation 290.

Aspects of the present invention may provide a method for receiving data based on a multiple peer-to-peer data transmission using multiple wireless communication methods. A peer terminal may search one or more seeder terminals. The one or more seeder terminals may be other peer terminals. The peer terminal may establish multiple wireless communication channels with the one or more seeder terminals. For example, the peer terminal may establish a is first wireless communication channel using Wi-Fi with a first seeder terminal, establish a second wireless communication channel using 3G mobile communication with a second seeder terminal, establish a third wireless communication channel using Wi-Fi with a third seeder terminal, and establish a fourth wireless communication channel using Bluetooth. The peer terminal may identify packets of a data file stored in each of the first, second, third and fourth seeder terminals by receiving packet storage information. The packet storage information of a seeder terminal may include total number of packets of a data file corresponding to the seed file, and packets of the data file stored in a seeder terminal. The peer terminal may identify the data transmission rate for each communication channel or identify the data transmission rate for each seeder terminal. The peer terminal may select one seeder terminal among seeder terminals which use the same wireless communication method based on the data transmission rate. For example, the first seeder terminal may be selected between the first seeder terminal and the third seeder terminal, which use Wi-Fi. The peer terminal may receive packets of the data file using the first, second and fourth wireless communication channels while not using the second wireless communication channel to avoid the bandwidth reduction of Wi-Fi communication network. The first, second and fourth wireless communication channels may be used to receive each packet of the data file sequentially or according to another packet order. If the first data packet is received through the first wireless communication channel, the second and fourth wireless communication channels may skip receiving the first packet and may start to download the next packet. Further, if multiple wireless communication channels are established, the peer terminal may divide portions of packets of a data file among the multiple wireless communication channels. For example, if the total number of packets of the data file is 3000, the first wireless communication channel may start to download from the first thousand packets, the second is wireless communication channel may start to download from the second thousand packets, and the fourth wireless communication channel may start to download from the third thousand packets.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

In addition, many modifications can be made to adapt a particular situation or material to the teachings of the present disclosure without departing from the essential scope thereof. Therefore, it is intended that the present disclosure not be limited to the particular exemplary embodiments disclosed as the best mode contemplated for carrying out the present disclosure, but that the present disclosure will include all embodiments falling within the scope of the appended claims.

1. A terminal, comprising:
an input unit to receive an instruction of a user;
a communication unit to transmit and receive data to and from other terminals; and
a control unit to determine a first seed file based on the instruction, to search other terminals having a second seed file corresponding to the first seed file, and to receive data corresponding to the second seed file from the searched other terminals using a wireless communication method.

2. The terminal of claim 1, wherein the control unit receives the data from one of the searched other terminals which provides a fastest data communication rate.

3. The terminal of claim 1, wherein the control unit receives the data using a communication method which provides a fastest data communication rate among multiple wireless communication methods.

4. The terminal of claim 2, wherein the control unit receives the data on a packet-by-packet basis, and
the control unit searches for a terminal, which provides a fastest data communication rate for each packet, and receives each packet of the data from a terminal, which provides the fastest data communication rate for the corresponding packet of the data.

5. The terminal of claim 1, wherein the control unit transmits data to another terminal which requests the transmission of data using a wireless communication method other than the wireless communication method used by the terminal to receive the data.

6. A method for data communication, the method comprising:
establishing a first wireless channel with one or more terminals;
determining a first seed file to receive data corresponding to the seed file;
searching one or more terminals having a second seed file corresponding to the first seed file; and
receiving data corresponding to the second seed file from the one or more terminals using the first wireless channel.

7. The method of claim 6, wherein the receiving of the data comprises:
determining a terminal which provides a fastest data communication rate among the one or more terminals based on data communication rate; and
receiving the data from the determined terminal.

8. The method of claim 7, wherein the receiving of the data from the determined terminal comprises:
determining a communication method among multiple wireless communication methods available for the determined terminal based on data communication rate; and
receiving the data using the communication method.

9. The method of claim 6, wherein the receiving of the data comprises:
searching each terminal which provides a fastest data communication rate for each packet of the data; and
receiving each packet of the data from each terminal which provides the fastest data communication rate for a corresponding packet.

10. The method of claim 6, further comprising:
transmitting data to a terminal using a wireless communication method different from a communication method used for the first wireless channel.
